(19) United States
(12) Patent Application Publication
(10) Pub. No.: US 2010/0139042 A1
(43) Pub. Date: Jun. 10, 2010

(54) HINGE AND COLLAPSIBLE DEVICE UTILIZING THE SAME

(75) Inventor: JUNG-BIN CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/472,328

(22) Filed: May 26, 2009

(30) Foreign Application Priority Data
Dec. 4, 2008 (CN) 200820303097.3

(51) Int. Cl. E05F 1/08; E05D 11/10

(52) U.S. Cl. 16/297; 16/277

(57) ABSTRACT

A hinge includes a first connecting member, a second connecting member, and a shaft. The second connecting member includes a sleeve. An elastic positioning tab extends from the second connecting member and neighbors the sleeve. The shaft includes a fixing portion fixed to the first connecting member, and a fixing rod rotatably passed through the sleeve. A positioning surface is defined in the shaft for resisting against the positioning tab. A collapsible device utilizing the hinge is disclosed.

### BACKGROUND

1. Technical Field

The disclosure relates to a hinge, and a collapsible device utilizing the same.

2. Description of Related Art

A collapsible device, such as a notebook computer, or a clamshell mobile phone, generally including a main body and a display often uses a hinge to interconnect the main body and the display. The hinge allows the display to be rotatable with respect to the main body, and to be folded with the main body for saving space.

A hinge normally includes a first element and a second element fixed to the main body and the display of the collapsible device, respectively. The first and second elements are rotatable relative to and in friction engagement with each other for maintaining the display at any angle with respect to the main body. Generally, a hook extends from the display, and a slot is defined in the main body. When the display is closed to the main body, the hook engages in the slot for fixing the display to the main body. However, it is quite inconvenient and costly to have and use the hook and the slot in the collapsible device.

### BRIEF DESCRIPTION OF THE DRAWINGS

FIG. 1 is an exploded, isometric view of a first embodiment of a hinge, the hinge including a first connecting member and a second connecting member.

FIG. 2 is an inverted view of the hinge of FIG. 1.

FIG. 3 is an assembled, isometric view of the hinge of FIG. 1.

FIG. 4 is similar to FIG. 3, but viewed from another perspective, and showing the second connecting member being rotated an angle relative to the first connecting member.

FIG. 5 is an isometric view of an exemplary embodiment of a collapsible device utilizing the hinge of FIG. 1.

FIG. 6 is an exploded, isometric view of a second embodiment of a hinge, similarly applicable for being utilized in the collapsible device of FIG. 5.

FIG. 7 is an exploded, isometric view of a third embodiment of a hinge, similarly applicable for being utilized in the collapsible device of FIG. 5.

### DETAILED DESCRIPTION

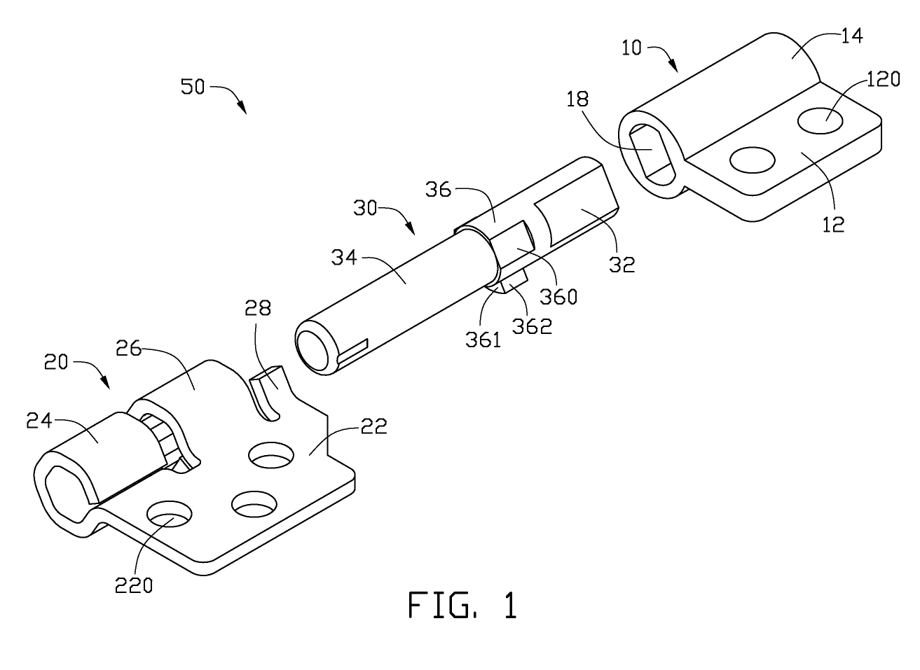

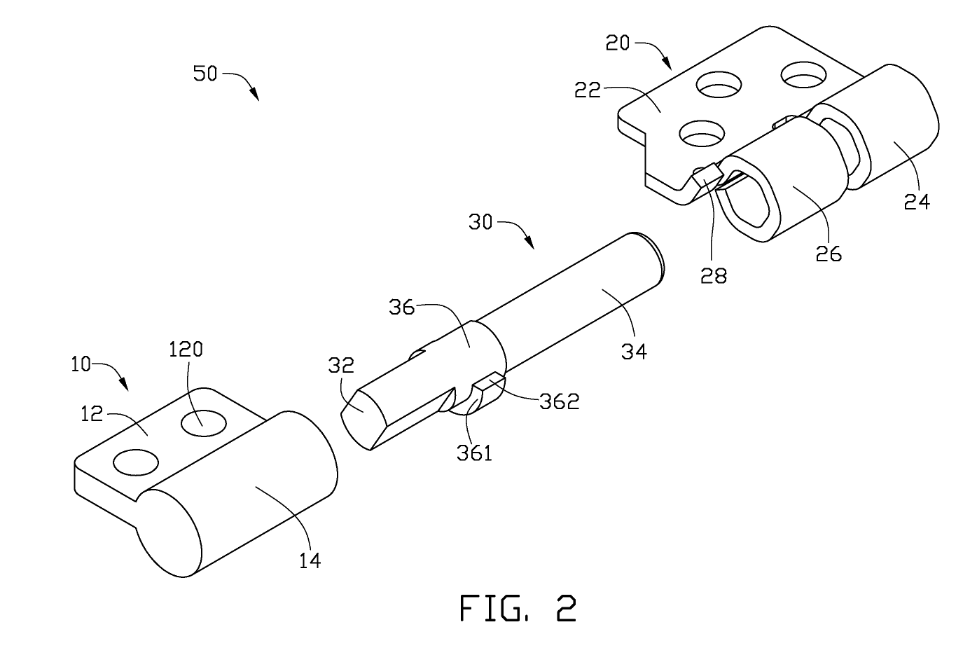

Referring to FIGS. 1 and 2, a first embodiment of a hinge 50 includes a first connecting member 10, a second connecting member 20, and a shaft 30 mounted between the first and second connecting members 10, 20.

The first connecting member 10 includes a connecting portion 12 defining a plurality of fixing holes 120 therein, and a cylinder-shaped fixing portion 14 located beside the connecting portion 12. The fixing portion 14 axially defines a fixing hole 18 having a double-D shape.

The second connecting member 20 includes a connecting block 22 defining a plurality of fixing holes 220 therein, and an elastic positioning tab 28 slantingly extending upwards from a side of the connecting block 22. Two separate portions respectively bend from the side of the connecting block 22, along two opposite directions to form a first curly sleeve 24 and a second curly sleeve 26. The first and second sleeves 24, 26 are coaxial, and the second sleeve 26 is located between the first sleeve 24 and the positioning tab 28.

The shaft 30 includes a fixing portion 32, a fixing rod 34, and a positioning portion 36. The fixing portion 32 having a double-D shaped cross-section corresponding to the fixing hole 18 of the first connecting member 10 extends from a first end of the positioning portion 36. The fixing rod 34 extends from a second end of the positioning portion 36. A flat positioning surface 360 is defined in a circumference of the positioning portion 36, and a resisting protrusion 361 protrudes out from the circumference of the positioning portion 36. The resisting protrusion 361 is opposite to the positioning surface 360, and includes two resisting surfaces 362 formed on corresponding ends of the resisting protrusion 361.

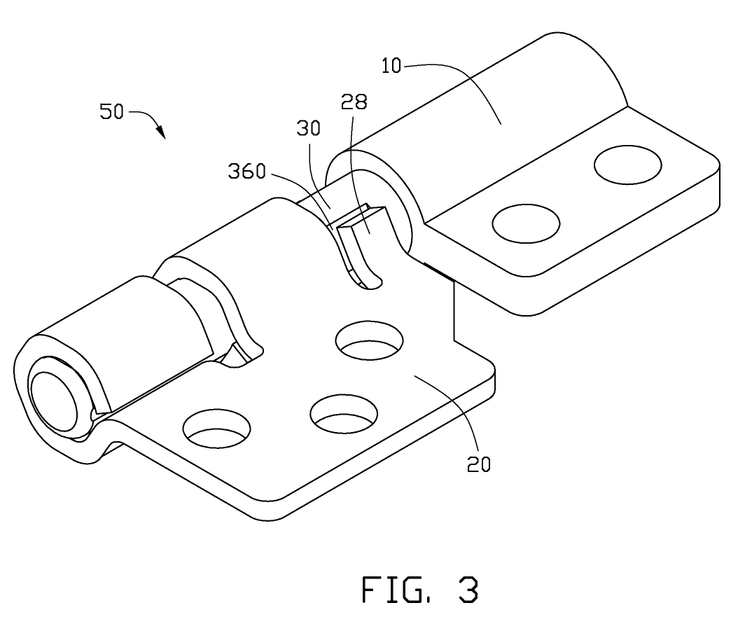

Referring to FIG. 3, in assembly, the fixing portion 32 of the shaft 30 is fixedly received in the fixing hole 18 of the first connecting member 10, therefore, the shaft 30 is fixed to the first connecting member 10. The fixing rod 34 of the shaft 30 is rotatably passed through the second sleeve 26 and the first sleeve 24 one by one in that order, with the positioning tab 28 slidably resisting against the circumference of the positioning portion 36.

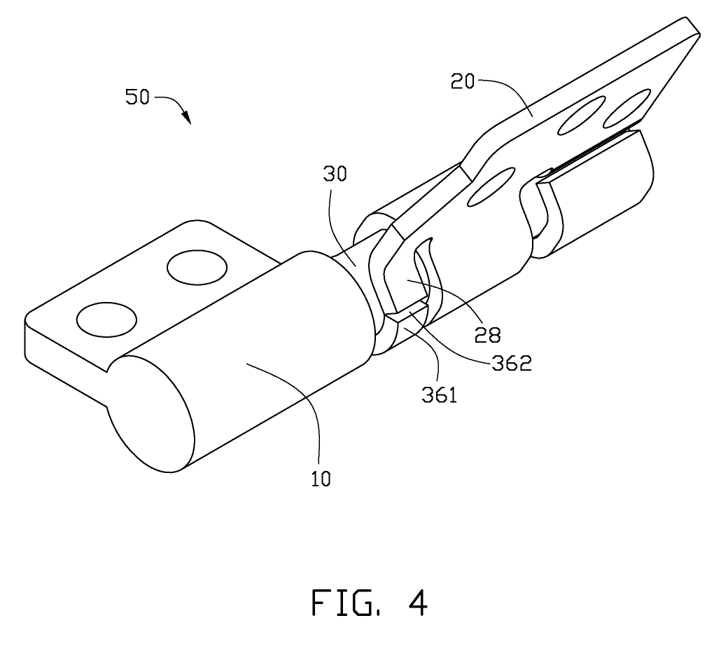

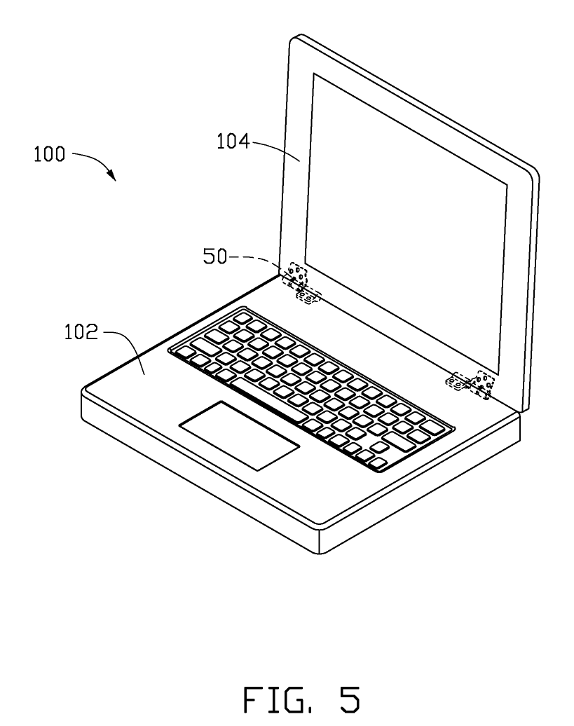

Referring to FIGS. 4 and 5, in use, the above-mentioned hinge 50 is utilized in a collapsible device 100, here for instance, in a notebook computer that includes a base 102 and a cover 104. The plurality of fixing holes 120 allows fastening members, such as screws, bolts, rivets etc., to extend therethrough, thereby fixing the first connecting member 10 to one of the cover 104 and the base 102. Similarly, the plurality of fixing holes 220 allows fastening members, such as screws, bolts, rivets etc., to extend therethrough, thereby the second connecting member 20 is fixed to the other one of the cover 104 and the base 102. Therefore, during rotation of the cover 104 or the base 102, the first connecting member 10 rotates relative to the second connecting member 20, with the shaft 30 freely rotating in the first and second sleeves 24, 26. As a result, friction between the shaft 30 and the first and second sleeves 24, 26 stably maintains positions of the cover 104 at any angle with respect to the base 102. In this process, the positioning tab 28 is slid to engage with or disengage from the positioning surface 360. When the cover 104 covers the base 102, the positioning tab 28 resists against the positioning surface 360, therefore, the first connecting member 10 needs much more force to rotate. As a result, the cover 104 cannot be opened unless enough force is used.

The first connecting member 10 cannot be rotated further when one of the resisting surface 362 resists against the positioning tab 28. As a result, the cover 104 cannot be over-rotated.

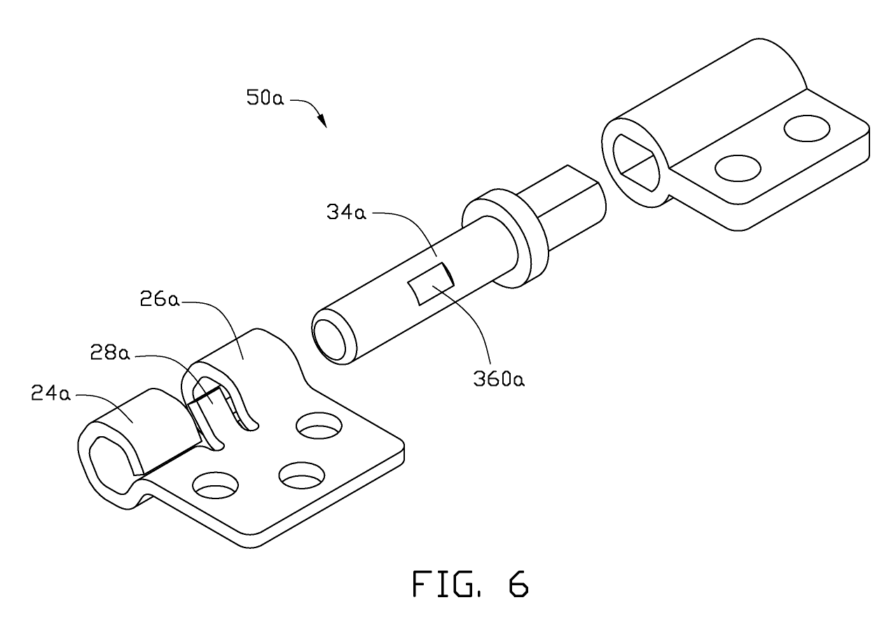

Referring to FIG. 6, a second embodiment of a hinge 50a is shown. The difference between this embodiment and the first embodiment being that a positioning tab 28a is between a first sleeve 24a and a second sleeve 26a. Correspondingly, a positioning surface 360a is defined in a fixing rod 34a for engaging with the positioning tab 28a.

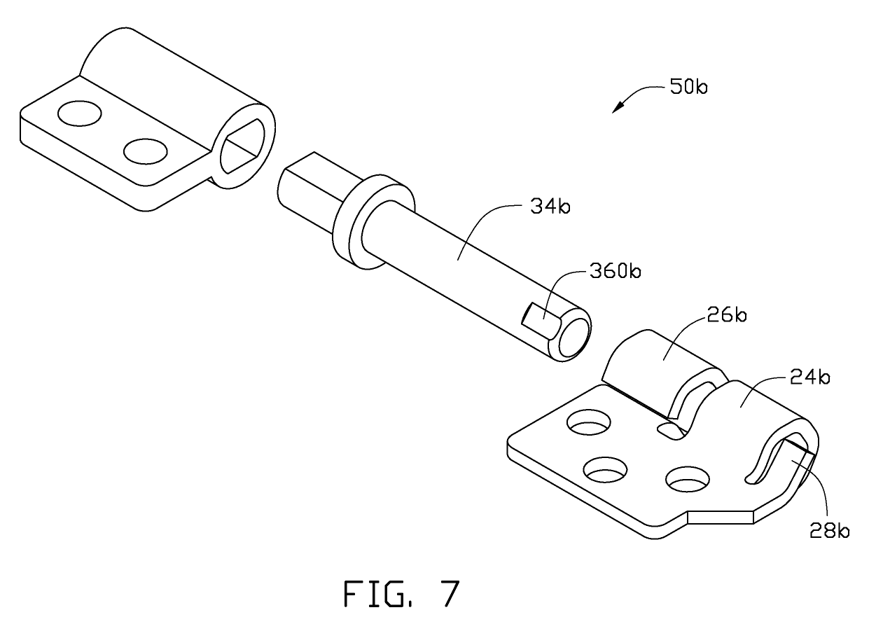

Referring to FIG. 7, a third embodiment of a hinge 50b is shown. The difference between this embodiment and the first embodiment is that a positioning tab 28b neighbors a first sleeve 24b, therefore, the first sleeve 24b is between the positioning tab 28b and a second sleeve 26b. Correspondingly, a positioning surface 360b is defined in a fixing rod 34b for engaging with the positioning tab 28a.

It is believed that the present embodiments and their advantages will be understood from the foregoing description, and it will be apparent that various changes may be made thereto without departing from the spirit and scope of the description or sacrificing all of its material advantages, the examples hereinbefore described merely being exemplary embodiments.

What is claimed is:

1. A hinge comprising,
a first connecting member;
a second connecting member comprising at least one sleeve, an elastic positioning tab neighboring the at least one sleeve; and
a shaft comprising a fixing portion fixed to the first connecting member, and a fixing rod rotatably passed through the at least one sleeve, wherein a positioning surface is defined in the shaft for resisting against the positioning tab.

2. The hinge of claim 1, wherein the shaft further comprises a positioning portion between the fixing portion and the fixing rod, the positioning surface is defined in the positioning portion.

3. The hinge of claim 2, wherein a resisting protrusion protrudes out from a circumference of the positioning portion and opposite to the positioning surface, the positioning tab can slide along the positioning portion and resist against the resisting protrusion.

4. The hinge of claim 3, wherein the resisting protrusion has two opposite ends to form two resisting surfaces, the positioning tab can selectively resist against the resisting surfaces.

5. The hinge of claim 1, wherein the at least one sleeve comprise a first sleeve and a second sleeve, the first and second sleeves are coaxial, the fixing rod is passed through the second and first sleeves.

6. The hinge of claim 5, wherein the second connecting member comprising a connecting block, two separate portions respectively bend from a side of the connecting block, along two opposite directions to form the first and second sleeves.

7. The hinge of claim 6, wherein the positioning tab slantingly extends upwards from the side of the connecting block, the second sleeve is between the positioning tab and the first sleeve.

8. The hinge of claim 6, wherein the positioning tab slantingly extends upwards from the side of the connecting block, and between the first and second sleeves.

9. The hinge of claim 6, wherein the positioning tab slantingly extends upwards from the side of the connecting block, the first sleeve is between the positioning tab and the second sleeve.

10. A collapsible device comprising:
a base;
a hinge comprising:
a first connecting member;
a second connecting member comprising at least one sleeve, an elastic positioning tab neighboring the at least one sleeve; and
a shaft comprising a fixing portion fixed to the first connecting member, and a fixing rod rotatably passed through the at least one sleeve, a positioning surface defined in the shaft for resisting against the positioning tab; and
a cover pivotally mounted to the base via the hinge;
wherein the first connecting member is fixed to one of the base and the cover, and the second connecting member is fixed to the other one of the base and the cover.

11. The collapsible device of claim 10, wherein the shaft further comprises a positioning portion between the fixing portion and the fixing rod, the positioning surface is defined in the positioning portion.

12. The collapsible device of claim 11, wherein a resisting protrusion protrudes out from a circumference of the positioning portion and opposite to the positioning surface, the positioning tab can slide along the positioning portion and resist against the resisting protrusion.

13. The collapsible device of claim 12, wherein the resisting protrusion has two opposite ends to form two resisting surfaces, the positioning tab can selectively resist against the resisting surfaces.

14. The collapsible device of claim 10, wherein the at least one sleeve comprise a first sleeve and a second sleeve, the first and second sleeves are coaxial, the fixing rod is passed through the second and first sleeves.

15. The collapsible device of claim 14, wherein the second connecting member comprising a connecting block to fix the corresponding one of the base and the cover, two separate portions respectively bend from a side of the connecting block, along two opposite directions to form the first and second sleeves.

16. The collapsible device of claim 15, wherein the positioning tab slantingly extends upwards from the side of the connecting block, the second sleeve is between the positioning tab and the first sleeve.

17. The collapsible device of claim 15, wherein the positioning tab slantingly extends upwards from the side of the connecting block, and between the first and second sleeves.

18. The collapsible device of claim 15, wherein the positioning tab slantingly extends upwards from the side of the connecting block, the first sleeve is between the positioning tab and the second sleeve.
